(19) United States
(12) Patent Application Publication
(10) Pub. No.: US 2024/0349102 A1
(43) Pub. Date: Oct. 17, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/624,142

(22) Filed: Apr. 2, 2024

(30) Foreign Application Priority Data
Apr. 13, 2023 (CN) 202310395760.6

(51) Int. Cl. H04W 24/10; H04L 5/00; H04W 76/20

(52) U.S. Cl. CPC H04W 24/10; H04L 5/0051; H04W 76/20

(57) ABSTRACT

The present application discloses a method and a device for wireless communications, including receiving a first signaling, the first signaling being used for configuration of measurements, including indicating a first report type and a second report type; both the first report type and the second report type being types of configured measurement reports; and reporting measurement results according to either of the first report type and the second report type; whether a first parameter set is indicated being used to determine whether to report measurement results according to the first report type or the second report type; the first parameter set being used to determine at least one of a downlink reception time or an uplink transmission time; this application allows for better reporting of measurement results via the first signaling.

### CROSS REFERENCE TO RELATED APPLICATIONS

This application claims the priority benefit of Chinese Patent Application No. 202310395760.6, filed on Apr. 13, 2023, the full disclosure of which is incorporated herein by reference.

### BACKGROUND

### Technical Field

The present application relates to transmission methods and devices in wireless communication systems, which concern the configuration of measurements, measurement reports and power conservation.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non-Terrestrial Network (NTN) and Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE can be connected to the network either directly or via a relay connection.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

The 3GPP standardization organization has worked on 5G standardization to formulate a series of specifications, of which the details can refer to:
https://www.3gpp.org/ftp/Specs/archive/38_series/38.133/38133-h00.zip
https://www.3gpp.org/ftp/Specs/archive/38_series/38.213/38213-h00.zip
https://www.3gpp.org/ftp/Specs/archive/38_series/38.321/38321-h00.zip
https://www.3gpp.org/ftp/Specs/archive/38_series/38.331/38331-h00.zip
https://www.3gpp.org/ftp/Specs/archive/38_series/38.304/38304-h00.zip

### SUMMARY

Measurement is a very important function in a wireless communication system, and measurement includes performing a measurement and reporting a measurement result, and a report type of the measurement result should depend on one of downlink reception time or uplink transmission time, otherwise, the reporting of the measurement result will bring some drawbacks, such as power consumption, or an impact on normal communication, or inaccuracy of the measurement result that leads to a miscalculation, and thus it is a problem to be solved for how to determine whether to report the measurement result based on a first report type or a second report type according to whether a first parameter set for determining at least one of the downlink reception time or the uplink transmission time is indicated. Researchers have found that when a cell indicates a different downlink reception time and uplink transmission time, the performing of measurements can be affected as well, while performing the measurements accurately is the basis for reporting accurate measurement results, making it all the more necessary to determine the report type based on whether or not the first parameter set is indicated. The researchers also found that when a cell enters into or leaves from a power-saving state, it needs to indicate, or must indicate, a different downlink reception time or uplink transmission time, and therefore, it is beneficial to assist in energy saving in the network by determining the report type based on whether the first parameter set is received. The researchers also found that when the network needs to change at least one of the downlink reception time and the uplink transmission time, the report type of each node can be modified in a dedicated way, but the signaling overhead is relatively high, and each node automatically determining a report type is beneficial in saving signaling overhead.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, the method proposed in the present application can also be used for addressing other issues confronting communications.

The present application provides a method in a first node for wireless communications, comprising:
receiving a first signaling, the first signaling being used for configuration of measurements, including indicating a first report type and a second report type; both the first report type and the second report type being types of configured measurement reports; and
reporting measurement results according to either of the first report type and the second report type; whether a first parameter set is indicated being used to determine whether to report measurement results according to the first report type or the second report type; the first parameter set being used to determine at least one of a downlink reception time or an uplink transmission time;
herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, a problem to be solved in the present application includes: how to determine a report type based on whether or not a first parameter set is received; how to determine a report type based on a change in an uplink transmission time; how to determine a report type based on a change in a downlink reception time; how to conserve electrical power; how to improve the accuracy of a report of measurement results; and how to save signaling overhead.

In one embodiment, the benefits of the above method include increased flexibility, power saving, improved accuracy of measurement reports, and avoidance of dropped calls and traffic interruptions.

Specifically, according to one aspect of the present application, the first signaling comprises a first report configuration, the first report configuration including the first report type; and the first signaling comprises a second report configuration, the second report configuration including the second report type.

Specifically, according to one aspect of the present application, the first signaling comprises a first report configuration, and both the first report type and the second report type are candidate report types of the first report configuration.

Specifically, according to one aspect of the present application, the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;
herein, the first measurement object includes at least a first reference signal resource, while the second measurement object includes at least a second reference signal resource.

Specifically, according to one aspect of the present application, whether the first parameter set is indicated is used to determine whether to perform measurements according to the first measurement object or the second measurement object;
herein, the meaning of the sentence whether the first parameter set is indicated is used to determine whether to perform measurements according to the first measurement object or the second measurement object is: when the first parameter set is indicated, performing measurements according to the first measurement object; when the first parameter set is not indicated, performing measurements according to the second measurement object.

Specifically, according to one aspect of the present application, one of the first report type and the second report type is periodical and the other is not periodical, or neither of the first report type and the second report type is periodical.

Specifically, according to one aspect of the present application, both the first report type and the second report type are periodical; the period of the first report type is different from the period of the second report type.

Specifically, according to one aspect of the present application, both the first report type and the second report type are event-triggered; triggering events of the first report type are different from triggering events of the second report type.

Specifically, according to one aspect of the present application, receiving a second signaling, the second signaling being used to indicate the first parameter set;
reporting measurement results according to the first report type as a response to receiving the second signaling;
receiving a third signaling after the second signaling is received, the third signaling being used to indicate a stop of application of the first parameter set; and
reporting measurement results according to the second report type as a response to receiving the third signaling;
herein, the second signaling and the third signaling are both transmitted by means of broadcasting.

Specifically, according to one aspect of the present application, the first node is a terminal of Internet of Things (IoT).

Specifically, according to one aspect of the present application, the first node is a UE.

Specifically, according to one aspect of the present application, the first node is a relay.

Specifically, according to one aspect of the present application, the first node is an access-network device.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

The present application provides a first node for wireless communications, comprising:
a first receiver, which receives a first signaling, the first signaling being used for configuration of measurements, including indicating a first report type and a second report type; both the first report type and the second report type being types of configured measurement reports; and
a first transmitter, which reports measurement results according to either of the first report type and the second report type; whether a first parameter set is indicated being used to determine whether to report measurement results according to the first report type or the second report type; the first parameter set being used to determine at least one of a downlink reception time or an uplink transmission time;
herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, compared with the prior art, the present application is advantageous in the following aspects:

It is more flexible, and supportive of more scenarios, more diverse cells and more diverse cell states; the signaling overhead is also smaller.

It is more power-efficient, saving both terminal power and network power.

It is favorable for mobility management, such as timely and accurate switching, avoiding service interruption or service quality degradation.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling and reporting measurement results according to either of a first report type and a second report type according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a downlink reception time according to one embodiment of the present application.

FIG. 7 illustrates a schematic diagram of an uplink transmission time according to one embodiment of the present application.

FIG. 8 illustrates a schematic diagram of a first parameter set being used to determine at least one of a downlink reception time or an uplink transmission time according to one embodiment of the present application.

FIG. 9 illustrates a schematic diagram of a second signaling being used to indicate a first parameter set according to one embodiment of the present application.

FIG. 10 illustrates a structure block diagram of a processing device in a first node according to one embodiment of the present application.

FIG. 11 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

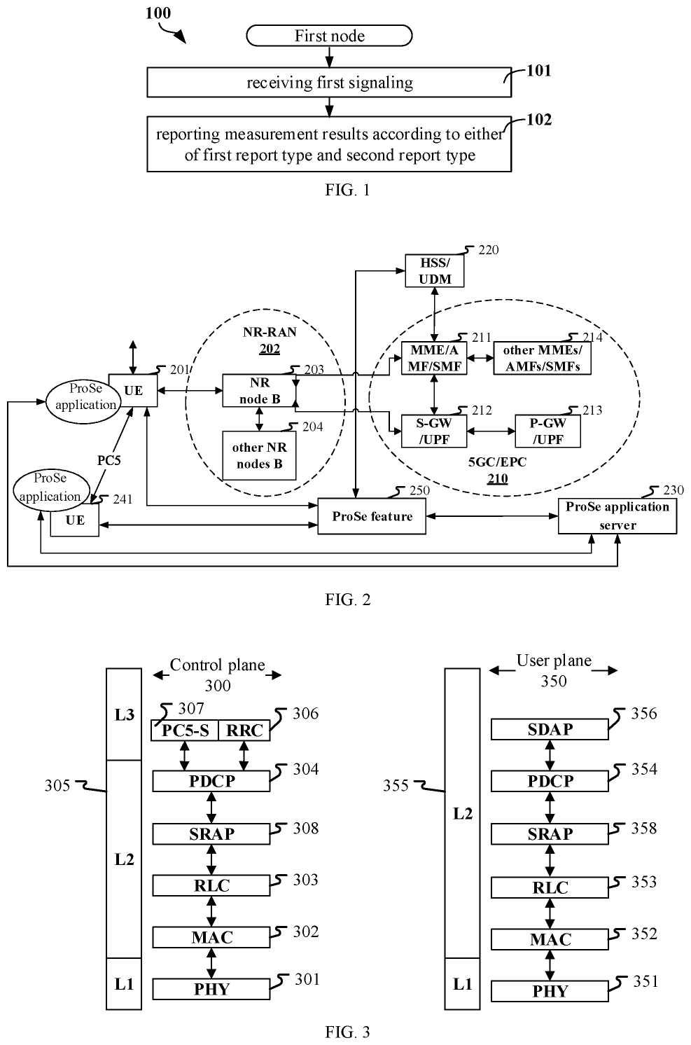

Embodiment 1 illustrates a flowchart of receiving a first signaling and reporting measurement results according to either of a first report type and a second report type according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101 and reports measurement results according to either of a first report type and a second report type in step 102;
herein, the first signaling is used for configuration of measurements, including indicating a first report type and a second report type; both the first report type and the second report type being types of configured measurement reports; whether a first parameter set is indicated being used to determine whether to report measurement results according to the first report type or the second report type; the first parameter set being used to determine at least one of a downlink reception time or an uplink transmission time; the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, the first node is a User Equipment (UE).

In one embodiment, the first node is in RRC_Connected state.

In one embodiment, the method proposed by the present application is unrelated to sidelink communications.

In one embodiment, the method proposed by the present application is applied to direct communication between a terminal and a network.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, relative to this UE, the cell being camped on is seen as a serving cell of the UE. Camping on a cell in either RRC_Idle state or RRC_Inactive state has the following benefits: it allows the UE to receive system information from the PLMN or SNPN; when registered, if the UE wishes to establish an RRC connection or continue a suspending RRC connection, the UE can do so by performing an initial access on the control channel of the camped cell; the network can page the UE; it allows the UE to receive Earthquake and Tsunami Warning System (ETWS) and Commercial Mobile Alert System (CMAS) notifications.

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); otherwise, the special cell refers to a PCell.

In one embodiment, working frequency of a Secondary Cell (SCell) is secondary frequency.

In one embodiment, separate contents in information elements (IEs) are referred to as fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, the first node is configured with at least an MCG.

In one subembodiment, the MCG of the first node comprises at least one SCell.

In one subembodiment, the MCG of the first node does not comprise a SCell.

In one embodiment, the first node is configured with an MCG and an SCG.

In one subembodiment, the MCG of the first node comprises at least one SCell.

In one subembodiment, the SCG of the first node comprises at least one SCell.

In one embodiment, an RRC information block refers to an information block (information element) in an RRC message.

In one embodiment, an SSB may be referred to as an SSPBCH or SS block.

In one embodiment, an RRC information block may include one or more RRC information blocks.

In one embodiment, an RRC information block does not have to include any RRC information block, but only includes at least one parameter.

In one embodiment, radio bearers include at least a signaling radio bearer and a data radio bearer.

In one embodiment, radio bearers include a multicast broadcast service (MBS) radio bearer.

In one embodiment, the radio bearer is services or an interface of services provided by the PDCP layer to higher layers.

In one subembodiment, the higher layers include one of an RRC layer, a NAS and a SDAP layer.

In one embodiment, a signaling radio bearer is services or an interface of services provided by the PDCP layer to higher layers for signaling transmission.

In one subembodiment, the higher layers include at least the former of an RRC layer and a NAS.

In one embodiment, a data radio bearer is services or an interface of services provided by the PDCP layer to higher layers for data transmission.

In one subembodiment, the higher layers include at least the former of a SDAP layer and a NAS

In one embodiment, the first signaling is an RRC signaling.

In one embodiment, the first signaling is transmitted in a unicast way.

In one embodiment, the first signaling is transmitted through a dedicated control channel (DCCH).

In one embodiment, the first signaling is transmitted to the first node via a dedicated means.

In one embodiment, the first signaling is transmitted to the first node via SRB1.

In one embodiment, the first signaling uses encryption.

In one embodiment, the first signaling is a signaling supported by the legacy device.

In one embodiment, the signaling supported by the legacy device is a signaling prior to 3GPP release 18.

In one embodiment, the signaling supported by the legacy device is a signaling in or prior to 3GPP release 17.

In one embodiment, the signaling supported by the legacy device is a signaling supported by a device manufactured prior to the filing of this application.

In one embodiment, the first signaling is or comprises an RRCReconfiguration message.

In one embodiment, the first signaling is or comprises an RRCConnectionReconfiguration message.

In one embodiment, the first signaling is used to configure measurements.

In one embodiment, the meaning of the phrase that the first signaling is used to configure measurements includes: the first signaling comprises measConfig.

In one embodiment, the meaning of the phrase that the first signaling is used to configure measurements includes: the first signaling adds or modifies at least one measurement identity.

In one subembodiment, any of the at least one measurement identity is associated with a measurement object identity and a report configuration identity.

In one subembodiment, any of the at least one measurement identity associates a measurement object with a report configuration.

In one embodiment, the meaning of the phrase that the first signaling is used to configure measurements includes: the first signaling being used to add or modify at least one measurement object.

In one embodiment, the meaning of the phrase that the first signaling is used to configure measurements includes: the first signaling being used to add or modify at least one report configuration.

In one embodiment, the meaning of the phrase that the first signaling is used to configure measurements includes: the first signaling being used to indicate a measurement gap.

In one embodiment, the meaning of the phrase that the first signaling is used to configure measurements includes: the first signaling being used to configure S-criterion, the S-criterion being used to control measurement.

In one subembodiment, the S-criterion is configured through s-MeasureConfig included in the first signaling.

In one subembodiment, the first node doesn't have to perform measurements when the quality of a radio link is better than a threshold indicated by the configured S-criterion.

In one subembodiment, the S-criterion includes a Reference Signal Receiving Power (RSRP) threshold.

In one embodiment, the meaning of the phrase that the first signaling is used to configure measurements includes: the first signaling being used to configure a filter parameter for a measurement.

In one embodiment, any measurement object is identified by a configured measurement object identity.

In one embodiment, any report configuration is identified by a configured report configuration identity.

In one embodiment, the first signaling comprises a first report configuration, the first report configuration comprising the first report type and the second report type.

In one subembodiment, the first report type and the second report type are both candidate report types (reportType) for the first report configuration.

In one embodiment, the first signaling comprises a first report configuration and a second report configuration, the first report configuration comprising the first report type, the second report configuration comprising the second report type.

In one subembodiment, the second report configuration does not comprise the first report type.

In one subembodiment, the first report configuration does not comprise the second report type.

In one subembodiment, the first report configuration and the second report configuration each belongs to a different measurement configuration (measConfig).

In one subembodiment, the first report configuration and the second report configuration each belongs to the same measurement configuration (measConfig).

In one embodiment, the first signaling comprises a first report configuration and a second report configuration, where the report type of the first report configuration is the first report type and the report type of the second report configuration is the second report type.

In one subembodiment, the first report configuration has only one report type.

In one subembodiment, the second report configuration has only one report type.

In one embodiment, a report configuration is configured by a reportConfig.

In one embodiment, a measurement object is configured by a measObject.

In one embodiment, the phrase configured measurement report means: a report configuration included in the first signaling.

In one embodiment, the phrase configured measurement report means: the network configuring a measurement report through a report configuration in the first signaling.

In one embodiment, the phrase configured measurement report means: a report configuration to which the first report type belongs.

In one embodiment, the phrase configured measurement report means: a report configuration to which the second report type belongs.

In one embodiment, the first report type comprises a triggering condition for a measurement report.

In one embodiment, the first report type comprises a reference signal type.

In one embodiment, the first report type comprises a reference signal resource type.

In one embodiment, the first report type comprises a number of reports.

In one embodiment, the first report type comprises an identity of a reporting cell.

In one embodiment, the first report type comprises a number of reporting cells.

In one embodiment, the first report type comprises cell(s) allowed to report.

In one embodiment, the first report type comprises a time interval of reports.

In one embodiment, the first report type comprises whether to report a measurement result of a neighboring cell.

In one embodiment, the first report type comprises whether to report a beam measurement result.

In one embodiment, the second report type comprises a triggering condition for a measurement report.

In one embodiment, the second report type comprises a reference signal type.

In one embodiment, the second report type comprises a reference signal resource type.

In one embodiment, the second report type comprises a number of reports.

In one embodiment, the second report type comprises an identity of a reporting cell.

In one embodiment, the second report type comprises a number of reporting cells.

In one embodiment, the second report type comprises cell(s) allowed to report.

In one embodiment, the second report type comprises a time interval of reports.

In one embodiment, the second report type comprises whether to report a measurement result of a neighboring cell.

In one embodiment, the second report type comprises whether to report a beam measurement result.

In one embodiment, the first report type is one of Periodical, eventTriggered, reportCGI, reportSFTD, condTriggerConfig-r16, cli-Periodical-r16, cli-EventTriggered-r16, or rxTxPeriodical-r17.

In one embodiment, the second report type is one of Periodical, eventTriggered, reportCGI, reportSFTD, condTriggerConfig-r16, cli-Periodical-r16, cli-EventTriggered-r16, or rxTxPeriodical-r17.

In one embodiment, each report type, such as Periodical, has at least one parameter to correspond to.

In one embodiment, the first signaling comprises a first measurement configuration, the first measurement configuration comprising the first report type and the second report type.

In one embodiment, the first signaling comprises a first measurement configuration and a second measurement configuration, the first measurement configuration comprising the first report type, the second measurement configuration comprising the second report type.

In one embodiment, the first measurement configuration is associated with a cell.

In one embodiment, the first measurement configuration is associated with an MCG.

In one embodiment, the first measurement configuration is associated with an SCG.

In one embodiment, the second measurement configuration is associated with a cell.

In one embodiment, the second measurement configuration is associated with an MCG.

In one embodiment, the second measurement configuration is associated with an SCG.

In one embodiment, the first report type and the second report type belong to a same measurement configuration.

In one embodiment, the first report type and the second report type belong to a same reportConfigToAddModList in a same measurement configuration.

In one embodiment, a report configuration to which the first report type belongs and a report configuration to which the second report type belongs belong to a same measurement configuration.

In one embodiment, a report configuration to which the first report type belongs and a report configuration to which the second report type belongs belong to a same reportConfigToAddModList in a same measurement configuration.

In one embodiment, both the first report type and the second report type are intended to trigger reporting of NR measurement results.

In one embodiment, both a report configuration to which the first report type belongs and a report configuration to which the second report type belongs are intended to trigger reporting of NR measurement results.

In one subembodiment, the first report type and the second report type belong to a same report configuration.

In one subembodiment, the first report type and the second report type belong to different report configurations.

In one subembodiment, the first report type belongs to reportConfigNR.

In one subembodiment, the second report type belongs to reportConfigNR.

In one embodiment, the first report type and the second report type are associated with a same report configuration identity.

In one embodiment, the first report type and the second report type are associated with different report configuration identities.

In one embodiment, the first report type and the second report type are both for an NR network.

In one embodiment, the first report type and the second report type are both for evolved networks after NR.

In one embodiment, reports of measurement results triggered by the first report type and the second report type include measurement results for NR networks.

In one embodiment, reports of measurement results triggered by the first report type and the second report type include measurement results for reference signal resources of NR.

In one embodiment, the first report type belongs to one reportConfigNR and the second report type belongs to another reportConfigNR.

In one embodiment, the first report type and the second report type belong to a same reportConfigNR.

In one embodiment, the phrase according to either of the first report type and the second report type means: either according to the first report type or according to the second report type.

In one embodiment, the phrase according to either of the first report type and the second report type means: either according to the first report type and not according to the second report type; or according to the second report type and not according to the first report type.

In one embodiment, the meaning of the sentence of reporting measurement results according to either of the first report type and the second report type comprises: the reported measurement results relate to whether it is according to the first report type or according to the second report type.

In one embodiment, the meaning of the sentence of reporting measurement results according to either of the first report type and the second report type comprises: reporting of the measurement results is triggered by the first report type, or reporting of the measurement results is triggered by the second report type.

In one embodiment, the meaning of the phrase reporting of the measurement results is or includes: sending a measurement report.

In one embodiment, the meaning of the phrase reporting of the measurement results is or includes: sending a MeasurementReport.

In one subembodiment, the MeasurementReport is an RRC message.

In one subembodiment, the MeasurementReport transmitted comprises at least measurement results.

In one subembodiment, the MeasurementReport transmitted comprises at least RSRP.

In one subembodiment, the MeasurementReport transmitted comprises at least a cell identity.

In one subembodiment, the MeasurementReport transmitted comprises at least beam quality.

In one subembodiment, the MeasurementReport transmitted comprises at least time information.

In one subembodiment, the MeasurementReport transmitted comprises at least a measurement value of a neighboring cell.

In one subembodiment, the MeasurementReport transmitted comprises at least a measurement result of a first cell.

In one subembodiment, the MeasurementReport transmitted comprises at least a measurement result of a SpCell.

In one embodiment, the first report type and the second report type are both for a first cell.

In one embodiment, the meaning of the sentence that the first report type and the second report type are both for a first cell comprises that a measurement configuration to which the first report type belongs and a measurement configuration to which the second report type belongs both configure measurements for the first cell.

In one embodiment, the meaning of the sentence that the first report type and the second report type are both for a first cell comprises that a report of measurement results triggered by the first report type and a report of measurement results triggered by the second report type both comprise measurements for the first cell.

In one embodiment, the meaning of the sentence that the first report type and the second report type are both for a first cell comprises that the first report type and the second report type both comprise an identity of the first cell.

In one embodiment, the meaning of the sentence that the first report type and the second report type are both for a first cell comprises that a measurement configuration to which the first report type belongs and a measurement configuration to which the second report type belongs both comprise an identity of the first cell.

In one embodiment, the first parameter set comprises at least one parameter.

In one embodiment, the first parameter set comprises at least two parameters.

In one embodiment, the first parameter set comprises at least a first time length.

In one embodiment, the first parameter set comprises at least a first period.

In one embodiment, the first parameter set is used to indicate the first cell.

In one embodiment, the first parameter set is applied to the first cell.

In one embodiment, the first parameter set is used to indicate entry into a first state.

In one embodiment, the first parameter set is used to indicate that at least the first cell enters into a first state.

In one embodiment, the first parameter set is parameter(s) related to the first state.

In one embodiment, the first state corresponds to a receiving and/or transmitting mode of a network.

In one embodiment, the first state is related to network power saving.

In one embodiment, the first state is related to different signal transmission methods.

In one embodiment, the first state is related to different signal reception methods.

In one embodiment, the first state is related to different methods of transmission and/or reception of reference signals.

In one embodiment, the first state is related to whether dynamic scheduling is supported.

In one embodiment, the first state is related to the way in which different reference signal resources are allocated.

In one embodiment, the first state is related to different transmit powers.

In one embodiment, the first state is related to different frequencies of transmission of broadcast signals.

In one embodiment, the first state is related to whether or not to transmit a broadcast signal.

In one embodiment, the first state is related to whether or not to transmit a synchronization signal block (SSB).

In one embodiment, the first state is related to whether to transmit a System Information Block1 (SIB1).

In one embodiment, the first state is unrelated to whether a single terminal is in an active time of a DRX group.

In one embodiment, the first state is related to a transmission mode of the PDCCH.

In one embodiment, a feature of a cell being in the first state comprises that the cell switches off data transmission based on dynamic scheduling.

In one embodiment, a feature of a cell being in the first state comprises that the cell stops dynamic scheduling.

In one embodiment, a feature of a cell being in the first state comprises that the cell stops any transmission.

In one embodiment, a feature of a cell being in the first state comprises that the cell stops any transmission of data.

In one embodiment, a feature of a cell being in the first state comprises that the cell stops semi-persistent scheduling.

In one embodiment, the first state is a state of network energy saving.

In one embodiment, the first state is a discontinuous transmission (DTX) state of a cell.

In one embodiment, the first state is a state in which DTX of a cell is inactive.

In one embodiment, the first state is a DRX state of a cell.

In one embodiment, the first state is a state in which DRX of a cell is inactive.

In one embodiment, the first state is a DRX and DTX state of a cell.

In one embodiment, the first state is a state of not receiving and/or not transmitting of a cell.

In one embodiment, the first parameter set is indicated in a non-unicast way.

In one embodiment, the first parameter set is indicated in a broadcast way.

In one embodiment, the first parameter set is indicated via a system information block.

In one embodiment, the first parameter set is indicated via a DCI.

In one embodiment, the first parameter set is indicated via a MAC CE.

In one embodiment, the first parameter set is not indicated via the first signaling.

In one embodiment, the first signaling comprises a first report configuration, the first report configuration including the first report type; and the first signaling comprises a second report configuration, the second report configuration including the second report type.

In one embodiment, the first report configuration and the second report configuration belong to a same measurement configuration (measConfig).

In one embodiment, the first signaling comprises a first report configuration, and both the first report type and the second report type are candidate report types of the first report configuration.

In one subembodiment, the first report configuration has only one active report type at the same time.

In one subembodiment, the meaning of the sentence whether a first parameter set is indicated being used to determine whether to report measurement results according to the first report type or the second report type is: when being indicated a first parameter set, the first report type is an active report type; when not being indicated a first parameter set, the second report type is an active report type.

In one subembodiment, the meaning of the sentence of reporting measurement results according to either of the first report type and the second report type comprises: reporting measurement results according to an active report type.

In one subembodiment, the meaning of the sentence of reporting measurement results according to either of the first report type and the second report type comprises: not reporting measurement results according to an inactive report type.

In one embodiment, the first signaling indicates a first measurement object and a second measurement object, the first report type being associated with the first measurement object; the second report type being associated with the second measurement object; each of the first measurement object and the second measurement object includes a first cell.

In one embodiment, the first parameter set is used to determine at least one of the downlink reception time or the uplink transmission time for the first cell.

In one embodiment, the first measurement object includes at least a first reference signal resource, while the second measurement object includes at least a second reference signal resource.

In one embodiment, measConfig included in the first signaling includes the first measurement object and the second measurement object.

In one embodiment, a first measurement configuration included in the first signaling includes the first measurement object and the second measurement object.

In one embodiment, the first measurement object and the second measurement object are both for NR.

In one embodiment, the measurement configuration included in the first signaling is not a measurement configuration at an application layer.

In one embodiment, measObjectToAddModList in the measurement configuration included in the first signaling includes the first measurement object and the second measurement object.

In one embodiment, the first measurement object is indicated by a measObjectNR field in the first signaling.

In one embodiment, the second measurement object is indicated by a measObjectNR field in the first signaling.

In one embodiment, the first measurement object comprises a synchronization signal block (SSB) frequency.

In one embodiment, the first measurement object comprises an SSB subcarrier spacing.

In one embodiment, the first measurement object comprises a reference signal configuration.

In one subembodiment, the reference signal configuration comprises at least a first reference signal resource and/or a configuration of the first reference signal resource.

In one subembodiment, the first reference signal resource comprises an SSB or SSB resource.

In one subembodiment, the first reference signal resource comprises a channel state information-reference signal (CSI-RS) or a CSI-RS resource.

In one embodiment, the first measurement object comprises a targeted cell.

In one embodiment, a cellsToAddModList included in the first measurement object includes the first cell.

In one embodiment, the first measurement object comprises a list of allowed cells.

In one embodiment, the first measurement object comprises a list of disallowed cells.

In one embodiment, the first measurement object comprises a threshold of measurement.

In one embodiment, the first measurement object comprises an offset of measurement.

In one embodiment, the first measurement object comprises an SSB Measurement Timing Configuration (SMTC) of measurement.

In one embodiment, the second measurement object comprises a synchronization signal block (SSB) frequency.

In one embodiment, the second measurement object comprises an SSB subcarrier spacing.

In one embodiment, the second measurement object comprises a reference signal configuration.

In one subembodiment, the reference signal configuration comprises at least a second reference signal resource and/or a configuration of the second reference signal resource.

In one subembodiment, the second reference signal resource comprises an SSB or SSB resource.

In one subembodiment, the second reference signal resource comprises a channel state information-reference signal (CSI-RS) or a CSI-RS resource.

In one embodiment, the second measurement object comprises a targeted cell.

In one embodiment, a cellsToAddModList included in the second measurement object includes the first cell.

In one embodiment, the second measurement object comprises a list of allowed cells.

In one embodiment, the second measurement object comprises a list of disallowed cells.

In one embodiment, the second measurement object comprises a threshold of measurement.

In one embodiment, the second measurement object comprises an offset of measurement.

In one embodiment, the second measurement object comprises an SSB Measurement Timing Configuration (SMTC) of measurement.

In one embodiment, a first measurement identity included in the first measurement configuration associates the first report configuration with the first measurement object.

In one subembodiment, the first measurement identity is a measId.

In one subembodiment, the first measurement identity comprises an identity of the first report configuration and an identity of the first measurement object.

In one subembodiment, the first report type belongs to the first report configuration.

In one embodiment, a second measurement identity included in the first measurement configuration associates the first report configuration with the first measurement object.

In one subembodiment, the first measurement identity is a measId.

In one subembodiment, the first measurement identity comprises an identity of the second report configuration and an identity of the second measurement object.

In one subembodiment, the second report type belongs to the second report configuration.

In one embodiment, the meaning of the sentence the first report type being associated with the first measurement object is that a report configuration to which the first report type belongs is associated with the first measurement object.

In one embodiment, the meaning of the sentence the first report type being associated with the first measurement object is that the reporting of measurement results triggered by the first report type is based on observation results of the first measurement object.

In one embodiment, the meaning of the sentence the first report type being associated with the first measurement object is that the reporting of measurement results triggered by the first report type is the result of measurement performed with respect to the first measurement object.

In one embodiment, the meaning of the sentence the second report type being associated with the second measurement object is that a report configuration to which the second report type belongs is associated with the second measurement object.

In one embodiment, the meaning of the sentence the second report type being associated with the second measurement object is that the reporting of measurement results triggered by the second report type is based on observation results of the second measurement object.

In one embodiment, the meaning of the sentence the second report type being associated with the second measurement object is that the reporting of measurement results triggered by the second report type is the result of measurement performed with respect to the second measurement object.

In one embodiment, the meaning of the sentence that each of the first measurement object and the second measurement object includes a first cell is that each of the first measurement object and the second measurement object includes an identity of the first cell.

In one embodiment, the meaning of the sentence that each of the first measurement object and the second measurement object includes a first cell is that a CellsToAddModList included by the first measurement object and a CellsToAddModList included by the second measurement object each comprise an identity of the first cell.

In one embodiment, the meaning of the sentence that each of the first measurement object and the second measurement object includes a first cell is that a measurement performed with respect to the first measurement object includes measuring the first cell; and a measurement performed with respect to the second measurement object includes measuring the first cell.

In one embodiment, the first cell is a serving cell of the first node.

In one embodiment, the first cell is a non-serving cell of the first node.

In one embodiment, the first cell is a neighboring cell of the first node.

In one embodiment, the first cell is a SpCell of the first node.

In one embodiment, the first cell is a PCell of the first node.

In one embodiment, the first cell is a PSCell of the first node.

In one embodiment, the first cell is a SCell of the first node.

In one embodiment, the first cell is active.

In one embodiment, the first cell is always active.

In one embodiment, the first measurement configuration includes the first measurement object and the second measurement object.

In one embodiment, whether the first parameter set is indicated is used to determine whether to perform measurements according to the first measurement object or the second measurement object;

herein, the meaning of the sentence whether the first parameter set is indicated is used to determine whether to perform measurements according to the first measurement object or the second measurement object is: when the first parameter set is indicated, performing measurements according to the first measurement object; when the first parameter set is not indicated, performing measurements according to the second measurement object.

In one embodiment, both the first report configuration and the second report configuration are associated with the same measurement object.

In one embodiment, the meaning of the phrase performing a measurement according to the first measurement object is or comprises: performing a measurement based on a reference signal indicated by the first measurement object.

In one embodiment, the meaning of the phrase performing a measurement according to the first measurement object is or comprises: performing a measurement based on a reference signal resource indicated by the first measurement object.

In one embodiment, the meaning of the phrase performing a measurement according to the first measurement object is or comprises: performing a measurement based on a parameter indicated by the first measurement object.

In one embodiment, the meaning of the phrase performing a measurement according to the first measurement object is or comprises: measuring a signal quality of a cell indicated by the first measurement object.

In one embodiment, the meaning of the phrase performing a measurement according to the second measurement object is or comprises: performing a measurement based on a reference signal indicated by the second measurement object.

In one embodiment, the meaning of the phrase performing a measurement according to the second measurement object is or comprises: performing a measurement based on a reference signal resource indicated by the second measurement object.

In one embodiment, the meaning of the phrase performing a measurement according to the second measurement object is or comprises: performing a measurement based on a parameter indicated by the second measurement object.

In one embodiment, the meaning of the phrase performing a measurement according to the second measurement object is or comprises: measuring a signal quality of a cell indicated by the second measurement object.

In one embodiment, the meaning of the sentence whether the first parameter set is indicated is used to determine whether to perform measurements according to the first measurement object or the second measurement object is: when the first parameter set is indicated, not performing measurements according to the second measurement object; when the first parameter set is not indicated, not performing measurements according to the first measurement object.

In one embodiment, one of the first report type and the second report type is periodical and the other is not periodical.

In one embodiment, the first report type is periodical; the second report type is not periodical.

In one subembodiment, the second report type is one of eventTriggered, reportCGI, reportSFTD, condTriggerConfig-r16, cli-Periodical-r16, cli-EventTriggered-r16 or rxTxPeriodical-r17.

In one embodiment, the second report type is periodical; the first report type is not periodical.

In one subembodiment, the first report type is one of eventTriggered, reportCGI, reportSFTD, condTriggerConfig-r16, cli-Periodical-r16, cli-EventTriggered-r16 or rxTxPeriodical-r17.

In one embodiment, at least one of the first report type and the second report type is not supported by a UE that only supports protocols prior to 3GPP Release 18.

In one embodiment, neither the first report type nor the second report type is periodical.

In one subembodiment, the first report type is the same as the second report type.

In one subembodiment, the first report type is not identical to the second report type.

In one subembodiment, the first report type has different parameters than the second report type.

In one subembodiment, the first report type includes at least one parameter that is not included by the second report type.

In one subembodiment, the second report type includes at least one parameter that is not included by the first report type.

In one subembodiment, the first report type has at least one different parameter from the second report type.

In one embodiment, both the first report type and the second report type are periodical.

In one subembodiment, the period (reportInterval) of the first report type is different from the period of the second report type.

In one subembodiment, a reference signal type (rsType) of the first report type is different from a reference signal type of the second report type.

In one subembodiment, a number of reports of the first report type is different from a number of reports (reportAmount) of the second report type.

In one subembodiment, the first report type and the second report type have different report quantities.

In one subembodiment, the first report type indicates the use of a list of allowed cells, while the second report type does not indicate the use of a list of allowed cells.

In one subembodiment, the first report type indicates reporting of a measurement result of a neighboring cell; the second report type does not indicate reporting of a measurement result of a neighboring cell.

In one embodiment, both the first report type and the second report type are event triggered.

In one subembodiment, (a) triggering event(s) of the first report type is(are) different from (a) triggering event(s) of the second report type.

In one subembodiment, triggering event(s) of the first report type is(are) at least one of Event A1, Event A2, Event A3, Event A4, Event A5, Event A6, Event D1, Event T1, Event I1, or Event L1.

In one subembodiment, triggering event(s) of the second report type is(are) at least one of Event AI, Event A2, Event A3, Event A4, Event A5, Event A6, Event D1, Event T1, Event I1, or Event L1.

In one subembodiment, (a) triggering event(s) of the first report type is(are) identical to (a) triggering event(s) of the second report type.

In one subembodiment, a threshold for triggering event(s) of the first report type is different from a threshold for triggering event(s) of the second report type.

In one subembodiment, the hysteresis in triggering event(s) of the first report type is different from the hysteresis in triggering event(s) of the second report type.

In one subembodiment, time required to trigger the triggering event(s) of the first report type (timetotrigger) is different from time required to trigger the triggering event(s) of the second report type.

In one subembodiment, an entry condition for triggering event(s) of the first report type is different from an entry condition for triggering event(s) of the second report type.

In one subembodiment, a departure condition for triggering event(s) of the first report type is different from a departure condition for triggering event(s) of the second report type.

In one subembodiment, triggering event(s) of the first report type needs/need to be reported on departure while triggering event(s) of the second report type does/do not need to be reported on departure.

In one subembodiment, triggering event(s) of the first report type does/do not need to be reported on departure while triggering event(s) of the second report type needs/need to be reported on departure.

In one subembodiment, triggering event(s) of the first report type and triggering event(s) of the second report type are of different reference signal types.

In one subembodiment, triggering event(s) of the first report type and triggering event(s) of the second report type have different periods of reporting.

In one subembodiment, triggering event(s) of the first report type and triggering event(s) of the second report type have different number of reports.

In one subembodiment, triggering event(s) of the first report type and triggering event(s) of the second report type have different maximum reference signal indexes (maxNrofRS-IndexesToReport) for reporting.

In one subembodiment, triggering event(s) of the first report type and triggering event(s) of the second report type differ in terms of whether to report beam measurement results.

In one subembodiment, triggering event(s) of the first report type and triggering event(s) of the second report type differ in terms of whether to include a measurement of a neighboring cell.

In one embodiment, the first report type and the second report type report different cell identities.

In one embodiment, the first report type and the second report type report different numbers of cells or lists of cells.

In one embodiment, the first report type and the second report type have different report configurations for Received Signal Strength Indicator (RSSI).

In one embodiment, the action of reporting measurement results includes reporting measurement results filtered by L3.

In one embodiment, the action of reporting measurement results includes reporting measurement results filtered by L1.

In one embodiment, a filter used for measurement results reported according to the first report type is different from a filter used for measurement results reported according to the second report type.

In one embodiment, parameters of a filter used for measurement results reported according to the first report type are different from parameters of a filter used for measurement results reported according to the second report type.

In one embodiment, the meaning of the phrase not being indicated a first parameter set comprises: the first parameter set is not received.

In one embodiment, the meaning of the phrase not being indicated a first parameter set comprises: the first parameter set is not established.

In one embodiment, the meaning of the phrase not being indicated a first parameter set comprises: the first parameter set is released.

In one embodiment, the meaning of the phrase not being indicated a first parameter set comprises: the first parameter set is not valid.

In one embodiment, the meaning of the phrase not being indicated a first parameter set comprises: the first parameter set is not used.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, a base station of the second node in the present application is the gNB 203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the gNB 203 is a MacroCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The PC5 Signaling (PC5-S) Protocol sublayer 307 is responsible for the signaling protocol processing of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. SRBs can be viewed as services or interfaces provided by the PDCP layer to higher layers, such as the RRC layer. In NR systems SRBs include SRB1, SRB2, SRB3, and SRB4 when sidelink communications is involved, which are respectively used to transmit different types of control signaling. The SRB is a bearer between the UE and an access network and is used to transmit control signalings, including RRC signaling, between the UE and the access network. SRB1 has special significance for UEs. After each UE establishes an RRC connection, it will have a SRB1 for transmitting RRC signaling, and most of the signalings are transmitted through SRB1. If SRB1 is interrupted or unavailable, the UE has to carry out RRC re-establishment. SRB2 is generally only used to transmit NAS signaling or signaling related to security. The UE does not have to configure SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.). For a UE involving relay services, its control plane can also comprise an Adaptation sublayer Sidelink Relay Adaptation Protocol (SRAP) 308, and its user plane can also comprise an Adaptation sublayer SRAP358. The introduction of the Adaptation layer is beneficial to lower layers, for instance, a MAC layer, or an RLC layer, to multiplex and/or distinguish data from multiple source UEs. For nodes not joined in relay communications, none of the PC5-S307, SRAP308 and SRAP358 will be needed in the process of communications.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the second signaling in the present application is generated by the RRC 306.

In one embodiment, the third signaling in the present application is generated by the RRC 306.

### Embodiment 4

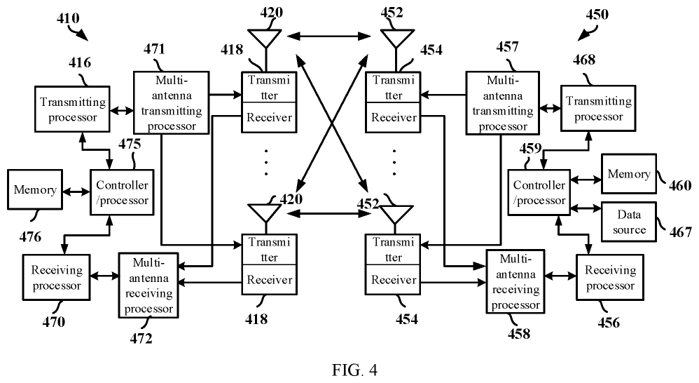

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450—targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 at least receives a first signaling, the first signaling being used for configuration of measurements, including indicating a first report type and a second report type; both the first report type and the second report type being types of configured measurement reports; and reports measurement results according to either of the first report type and the second report type; whether a first parameter set is indicated being used to determine whether to report measurement results according to the first report type or the second report type; the first parameter set being used to determine at least one of a downlink reception time or an uplink transmission time; herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, the first communication device 450 comprises a memory that stores a computer readable instruction program. The computer readable instruction program generates actions when executed by at least one processor. The actions include: receiving a first signaling, the first signaling being used for configuration of measurements, including indicating a first report type and a second report type; both the first report type and the second report type being types of configured measurement reports; and
reporting measurement results according to either of the first report type and the second report type; whether a first parameter set is indicated being used to determine whether to report measurement results according to the first report type or the second report type; the first parameter set being used to determine at least one of a downlink reception time or an uplink transmission time;
herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling used for configuring a first threshold; the receiver of the first signaling, performing a first measurement as a response to any condition in a first condition set being satisfied; herein, the first measurement includes L3-filtered beam measurement and cell measurement, and two conditions in the first condition set are that the RSRP of the first cell after L3 filtering is below a first threshold and that a first message that is applied to the first cell is received; the first cell is a SpCell; the first message is non-unicast and/or, the first message is not supported by a legacy device.

In one embodiment, the second communication device 410 comprises a memory that stores a computer readable instruction program. The computer readable instruction program generates actions when executed by at least one processor. The actions include: transmitting a first signaling, the first signaling used for configuring a first threshold; the receiver of the first signaling, performing a first measurement as a response to any condition in a first condition set being satisfied; herein, the first measurement includes L3-filtered beam measurement and cell measurement, and two conditions in the first condition set are that the RSRP of the first cell after L3 filtering is below a first threshold and that a first message that is applied to the first cell is received; the first cell is a SpCell; the first message is non-unicast and/or, the first message is not supported by a legacy device.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used for receiving the first signaling in the present application.

In one embodiment, the receiver 454 (comprising the antenna 452), the receiving processor 456 and the controller/processor 459 are used for receiving the second signaling in the present application.

In one embodiment, the receiver 454 (comprising the antenna 452), the receiving processor 456 and the controller/processor 459 are used for receiving the first message in the present application.

In one embodiment, the transmitter 454 (comprising the antenna 452), the transmitting processor 468 and the controller/processor 459 are used for transmitting the second message in the present application.

In one embodiment, the transmitter 418 (comprising the antenna 420), the transmitting processor 416 and the controller/processor 475 are used for transmitting the first signaling in the present application.

In one embodiment, the transmitter 418 (comprising the antenna 420), the transmitting processor 416 and the controller/processor 475 are used for transmitting the second signaling in the present application.

In one embodiment, the transmitter 418 (comprising the antenna 420), the transmitting processor 416 and the controller/processor 475 are used for transmitting the first message in the present application.

In one embodiment, the receiver 418 (comprising the antenna 420), the receiving processor 470 and the controller/processor 475 are used for receiving the second message in the present application.

### Embodiment 5

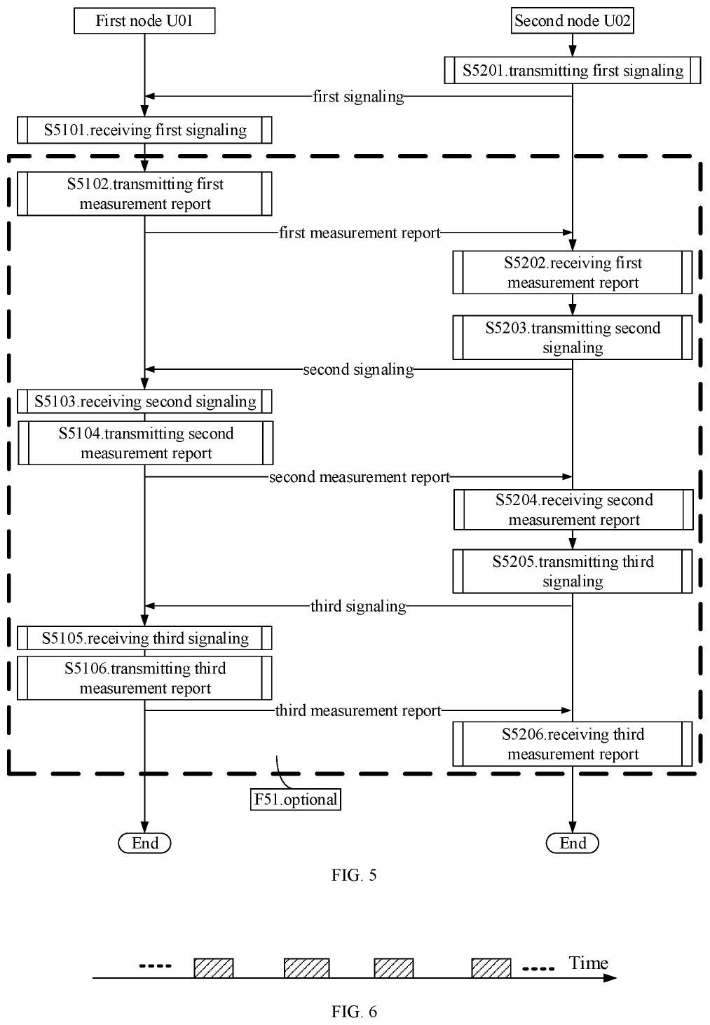

Embodiment 5 illustrates a flowchart of radio signal transmission according to one embodiment of the present application, as shown in FIG. 5. In FIG. 5, U01 corresponds to the first node in the present application. It should be particularly noted that the sequence illustrated herein does not set any limit on the orders in which signals are transmitted and implementations in this present application. Herein, steps in F51 are optional.

The first node U01 receives a first signaling in step S5101; transmits a first measurement report in step S5102; receives a second signaling in step S5103; transmits a second measurement report in step S5104; receives a third signaling in step S5105; and transmits a third measurement report in step S5106.

The second node U02 transmits a first signaling in step S5201; receives a first measurement report in step S5202; transmits a second signaling in step S5203; receives a second measurement report in step S5204; transmits a third signaling in step S5205; and receives a third measurement report in step S5206.

In Embodiment 5, the first signaling is used for configuration of measurements, including indicating a first report type and a second report type; both the first report type and the second report type being types of configured measurement reports; whether a first parameter set is indicated being used to determine whether to report measurement results according to the first report type or the second report type; the first parameter set being used to determine at least one of a downlink reception time or an uplink transmission time;
herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, the second node U02 is a SpCell of the first node U01.

In one embodiment, the second node U02 is an MCG of the first node U01.

In one embodiment, the second node U02 is the first cell.

In one embodiment, the second node U02 is a PCell of the first node U01 or a base station corresponding to the PCell of the first node U01.

In one embodiment, the communication interface between the first node U01 and the second node U02 is a Uu interface.

In one embodiment, the step S5102 is after the step S5101.

In one embodiment, the step S5102 is before the step S5103.

In one embodiment, the step S5103 is before the step S5102, or, the step S5103 is after the step S5102.

In one embodiment, the step S5104 is after the step S5103.

In one embodiment, the step S5104 is before the step S5105.

In one embodiment, the step S5106 is after the step S5105.

In one embodiment, the step S5105 is after the step S5103.

In one embodiment, an air interface between the first node U01 and the second node U02 is a Uu interface.

In one embodiment, the second node U02 belongs to the NR network.

In one embodiment, an RRC connection is established between the first node U01 and a network to which the second node U02 belongs.

In one embodiment, the meaning of the action of reporting measurement results according to either of the first report type and the second report type is or comprises: performing step S5102.

In one embodiment, the meaning of the action of reporting measurement results according to either of the first report type and the second report type is or comprises: using either of the first report type and the second report type as a triggering condition for reporting the measurement results.

In one embodiment, the meaning of the action of reporting measurement results according to either of the first report type and the second report type is or comprises: using either of the first report type and the second report type as a triggering condition for transmitting the first measurement report.

In one embodiment, the meaning of the action of reporting measurement results according to either of the first report type and the second report type is or comprises: using either of the first report type and the second report type to control the reporting of the measurement results.

In one embodiment, each of the first measurement report, the second measurement report and the third measurement report respectively comprises an RRC message.

In one embodiment, each of the first measurement report, the second measurement report and the third measurement report respectively comprises a MeasurementReport message.

In one embodiment, each of the first measurement report, the second measurement report and the third measurement report respectively comprises MeasResults.

In one embodiment, the first measurement report comprises a measurement result of the first cell.

In one embodiment, the first measurement report comprises an identity of the first measurement configuration.

In one embodiment, the first measurement report comprises an identity of the first cell.

In one embodiment, the first measurement report is for NR.

In one embodiment, the first measurement report comprises MeasResultListNR.

In one embodiment, the first report type is related to a CSI measurement or a CSI report.

In one embodiment, the second report type is related to a CSI measurement or a CSI report.

In one embodiment, the second measurement report comprises a measurement result of the first cell.

In one embodiment, the second measurement report comprises an identity of the first measurement configuration.

In one embodiment, the second measurement report comprises an identity of the first cell.

In one embodiment, the second measurement report is for NR.

In one embodiment, the second measurement report comprises MeasResultListNR.

In one embodiment, when the step S5103 is present, the first node U01 performs the step S5104 according to the first report type.

In one embodiment, when the step S5103 is not present, the first node U01 performs the step S5104 according to the second report type.

In one embodiment, before the step S5103 the first node U01 has received the first parameter set.

In one subembodiment, the first node U01, performs the step S5102 according to the second report type.

In one embodiment, the second measurement report comprises a measurement result of the first cell.

In one embodiment, the second measurement report comprises an identity of the first measurement configuration.

In one embodiment, the second measurement report comprises an identity of the first cell.

In one embodiment, the second measurement report is for NR.

In one embodiment, the second measurement report comprises MeasResultListNR.

In one embodiment, the step S5103 and step S5105 are present at the same time, or absent at the same time.

In one embodiment, the second signaling is transmitted in a broadcast way.

In one embodiment, the second signaling comprises a system information block.

In one embodiment, the second signaling comprises a system information block 1 (SIB1).

In one embodiment, the second signaling comprises a MAC Control Element (CE).

In one embodiment, the second signaling comprises downlink control information (DCI).

In one embodiment, the second signaling is not encrypted.

In one embodiment, the second signaling need not be fed back.

In one embodiment, the first node U01, after receiving the second signaling and before receiving the third signaling, reports a measurement result according to the first report type.

In one subembodiment, the meaning of reporting a measurement result according to the first report type comprises: transmitting the second measurement report according to the first report type.

In one embodiment, the first node U01 reports a measurement result according to the second report type after receiving the third signaling.

In one subembodiment, the meaning of reporting a measurement result according to the second report type comprises: transmitting the third measurement report according to the second report type.

In one embodiment, the third measurement report comprises a measurement result of the first cell.

In one embodiment, the third measurement report comprises an identity of the first measurement configuration.

In one embodiment, the third measurement report comprises an identity of the first cell.

In one embodiment, the third measurement report is for NR.

In one embodiment, the third measurement report comprises MeasResultListNR.

In one embodiment, the first measurement report is obtained based on the second measurement object.

In one embodiment, the second measurement report is obtained based on the first measurement object.

In one embodiment, the third measurement report is obtained based on the second measurement object.

In one embodiment, the third signaling is used to indicate a stop of application of the first parameter set.

In one embodiment, the meaning of the sentence that the third signaling is used to indicate a stop of application of the first parameter set includes: the third signaling indicates a departure from the first state.

In one embodiment, the meaning of the sentence that the third signaling is used to indicate a stop of application of the first parameter set includes: the third signaling indicates the first cell's departure from the first state.

In one embodiment, the meaning of the sentence that the third signaling is used to indicate a stop of application of the first parameter set includes: the third signaling is used for releasing the first parameter set.

In one embodiment, the meaning of the sentence that the third signaling is used to indicate a stop of application of the first parameter set includes: the third signaling is used for releasing a configuration to which the first parameter set belongs.

In one embodiment, an RRC signaling preceding the second signaling is used to establish a configuration to which the first parameter set belongs.

In one embodiment, the meaning of the sentence that the third signaling is used to indicate a stop of application of the first parameter set includes: the third signaling indicates that the downlink reception time is not limited.

In one embodiment, the meaning of the sentence that the third signaling is used to indicate a stop of application of the first parameter set includes: the third signaling indicates that the downlink reception time is not limited.

In one embodiment, the meaning of the sentence that the third signaling is used to indicate a stop of application of the first parameter set includes: the third signaling indicates a second parameter set, the second parameter set indicating a downlink reception time different from the downlink reception time determined by the first parameter set.

In one subembodiment, the second parameter set indicates a downlink reception time that is more generous than the downlink reception time determined by the first parameter set.

In one embodiment, the meaning of the sentence that the third signaling is used to indicate a stop of application of the first parameter set includes: the third signaling indicates a second parameter set, the second parameter set indicating a downlink reception time different from the downlink reception time determined by the first parameter set.

In one subembodiment, the second parameter set indicates an uplink transmission time that is more generous than the uplink transmission time determined by the first parameter set.

In one embodiment, the meaning of the sentence that the third signaling is used to indicate a stop of application of the first parameter set includes: the third signaling is used to indicate that the second signaling is no longer valid.

In one embodiment, the meaning of the sentence that the third signaling is used to indicate a stop of application of the first parameter set includes: the first parameter set is no longer applied to the first cell.

In one embodiment, the report of measurement results is a measurementReport.

In one embodiment, the first measurement report is a report of measurement results.

In one embodiment, the second measurement report is a report of measurement results.

In one embodiment, the third measurement report is a report of measurement results.

In one embodiment, reports of measurement results triggered by the first report type and the second report type are different in time.

In one embodiment, reports of measurement results triggered by the first report type and the second report type are different in periodicity.

In one embodiment, reports of measurement results triggered by the first report type and the second report type are different in triggering event.

In one embodiment, reports of measurement results triggered by the first report type and the second report type are different in triggering threshold.

In one embodiment, reports of measurement results triggered by the first report type and the second report type are different in measurement results.

In one embodiment, reports of measurement results triggered by the first report type and the second report type are different in cells being included or targeted.

In one embodiment, the third signaling is or comprises a system information block.

In one embodiment, the third signaling comprises a SIB1.

In one embodiment, the third signaling is or comprises a MAC CE.

In one embodiment, the third signaling is or comprises DCI.

In one embodiment, the second signaling is used to indicate the first parameter set.

In one embodiment, the first node U01 reports a measurement result according to the first report type as a response to receiving the second signaling.

In one embodiment, the third signaling is used to indicate a stop of application of the first parameter set.

In one embodiment, the first node U01 reports a measurement result according to the second report type as a response to receiving the third signaling.

In one embodiment, the second signaling is scrambled using a specific RNTI.

In one subembodiment, the specific RNTI is not a C-RNTI.

In one subembodiment, the specific RNTI is not a G-RNTI.

In one subembodiment, the specific RNTI is not a SI-RNTI.

In one subembodiment, the specific RNTI is a broadcast or multicast type RNTI.

In one subembodiment, the specific RNTI is an N-RNTI.

In one subembodiment, the specific RNTI is a NS-RNTI.

In one subembodiment, the specific RNTI is a NES-RNTI.

In one subembodiment, the specific RNTI is a P-RNTI.

In one subembodiment, the specific RNTI is not a P-RNTI.

In one embodiment, the third signaling is scrambled using a specific RNTI.

In one subembodiment, the specific RNTI is not a C-RNTI.

In one subembodiment, the specific RNTI is not a G-RNTI.

In one subembodiment, the specific RNTI is not a SI-RNTI.

In one subembodiment, the specific RNTI is a broadcast or multicast type RNTI.

In one subembodiment, the specific RNTI is a N-RNTI.

In one subembodiment, the specific RNTI is a NS-RNTI.

In one subembodiment, the specific RNTI is a NES-RNTI.

In one subembodiment, the specific RNTI is a P-RNTI.

In one subembodiment, the specific RNTI is not a P-RNTI.

In one embodiment, the second signaling and the third signaling are scrambled by the same RNTI.

### Embodiment 6

Embodiment 6 illustrates a schematic diagram of a downlink reception time according to one embodiment of the present application, as shown in FIG. 6.

FIG. 6 illustrates the downlink reception time determined by the first parameter set, with the shaded rectangular squares denoting the downlink reception time and the portion other than the shaded rectangular squares denoting the non-downlink reception time; the method proposed in the present application does not limit a start time and an end time as well as the length of the downlink reception time, i.e., it does not limit the number of shaded squares and the length of the shaded squares in the FIG. 6.

In one embodiment, the first node is required to listen into a physical downlink control channel (PDCCH) during the downlink reception time.

In one embodiment, the first node is required to listen into a physical downlink control channel (PDCCH) for C-RNTI during the downlink reception time.

In one embodiment, the first node does not expect to receive HARQ feedback at a time other than the downlink reception time.

In one embodiment, the first node does not expect to be scheduled at a time other than the downlink reception time.

In one embodiment, the first node is not required to listen into a PDCCH at a time other than the downlink reception time.

In one embodiment, the first node is not required to listen into a PDCCH for a C-RNTI at a time other than the downlink reception time.

In one embodiment, the downlink reception time applies to a system information block.

In one embodiment, the downlink reception time applies to DCI.

In one embodiment, the downlink reception time applies to a reference signal or a reference signal resource.

In one embodiment, the downlink reception time applies to SSB or SS/PBCH.

In one embodiment, the downlink reception time applies to CSI-RS.

In one embodiment, the downlink reception time is applicable to semi persistent scheduling (SPS).

In one embodiment, the downlink reception time determined by the first parameter set comprises a start of the downlink reception time.

In one embodiment, the downlink reception time determined by the first parameter set always lasts after the start.

In one embodiment, the downlink reception time determined by the first parameter set comprises a start and an end of the downlink reception time.

In one embodiment, the downlink reception time determined by the first parameter set comprises multiple discontinuous time periods.

In one embodiment, the downlink reception time determined by the first parameter set comprises a finite number of discontinuous time periods.

In one embodiment, the downlink reception time determined by the first parameter set comprises an infinite number of discontinuous time periods.

In one embodiment, the downlink reception time determined by the first parameter set comprises multiple time periods.

In one subembodiment, each of the multiple time periods is of equal length.

In one subembodiment, the multiple time periods include at least two time periods of unequal lengths.

In one subembodiment, any two adjacent time periods among the multiple time periods are spaced apart from each other by equal time interval.

In one subembodiment, the multiple time periods include at least one pair of adjacent time periods with a time interval between them not equal to a time interval between another pair of adjacent time periods.

In one embodiment, the first parameter set explicitly indicates a parameter for downlink reception time.

In one embodiment, the first parameter set indicates which of previous configurations is used to configure the downlink reception time.

In one subembodiment, the first parameter set indicates a configuration index.

In one subembodiment, the network configures a candidate downlink reception time before the first parameter set.

In one embodiment, the first parameter set includes a time for transmitting a system information block.

In one embodiment, the first parameter set comprises a time for transmitting an SSB.

In one embodiment, the first parameter set comprises a first factor, the first factor being used together with a first time length to determine the downlink reception time.

In one subembodiment, the first factor is a scaling factor.

In one subembodiment, the first time length is a period of a SIB.

In one subembodiment, the first time length is a period of a SIB1.

In one subembodiment, the first time length is a period of an SSB.

In one subembodiment, the first time length is a period of paging.

In one subembodiment, the first time length is a period of Discontinuous Reception.

In one subembodiment, the first factor is unequal to 1.

In one subembodiment, the first factor is greater than 1.

In one subembodiment, the product of the first factor and the first time length is used to determine a time interval between any two adjacent time periods among the multiple time periods.

In one embodiment, the first parameter set indicates the downlink reception time by indicating the time other than the downlink reception time.

In one embodiment, the downlink reception time is for the first cell.

In one embodiment, the downlink reception time is a time while the first cell is in an active state.

In one embodiment, the downlink reception time is a time while the first cell is in the first state.

In one embodiment, the downlink reception time is a time while the first cell is in a non-network energy saving (non-NES) state.

In one embodiment, the downlink reception time is a time other than the time while the first cell is in DTX.

In one embodiment, the downlink reception time is an active time while the first cell is in DTX.

In one embodiment, the first parameter set comprises at least one time parameter of a reference signal resource.

In one embodiment, the first parameter set comprises a period of the downlink reception time.

In one embodiment, the first parameter set comprises a period of a time period of the downlink reception time.

In one embodiment, the first parameter set comprises time window information for a system information block.

In one embodiment, the period of the time period included in the downlink reception time is equal to the period of the system information block.

### Embodiment 7

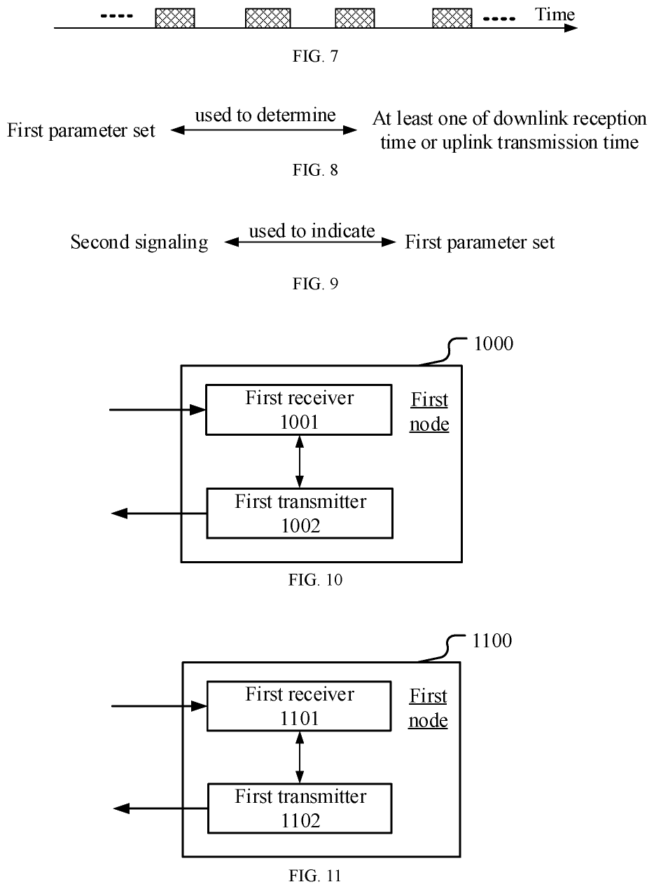

Embodiment 7 illustrates a schematic diagram of an uplink transmission time according to one embodiment of the present application, as shown in FIG. 7.

FIG. 7 illustrates the uplink transmission time determined by the first parameter set, with the shaded rectangular squares denoting the uplink transmission time and the portion other than the shaded rectangular squares denoting the non-uplink transmission time; the method proposed in the present application does not limit a start time and an end time as well as the length of the uplink transmission time, i.e., it does not limit the number of shaded squares and the length of the shaded squares in the FIG. 7.

In one embodiment, the first node performs uplink transmission during the uplink transmission time.

In one embodiment, the first node is not required to transmit at a time other than the uplink transmission time.

In one embodiment, the first node doesn't expect to be indicated that it shall perform an uplink transmission at a time other than the uplink transmission time.

In one embodiment, the uplink transmission time applies to data.

In one embodiment, the uplink transmission time applies to signaling.

In one embodiment, the uplink transmission time applies to uplink control information (UCI).

In one embodiment, the uplink transmission time applies to a MAC CE.

In one embodiment, the uplink transmission time applies to a reference signal or a reference signal resource.

In one embodiment, the uplink transmission time applies to a sounding reference signal (SRS).

In one embodiment, the uplink transmission time applies to configured grant (CG).

In one embodiment, an uplink transmission time determined by the first parameter set comprises a start of the uplink transmission time.

In one embodiment, an uplink transmission time determined by the first parameter set always lasts after the start.

In one embodiment, an uplink transmission time determined by the first parameter set comprises a start and an end of the uplink transmission time.

In one embodiment, an uplink transmission time determined by the first parameter set comprises multiple discontinuous time periods.

In one embodiment, an uplink transmission time determined by the first parameter set comprises a finite number of discontinuous time periods.

In one embodiment, an uplink transmission time determined by the first parameter set comprises an infinite number of discontinuous time periods.

In one embodiment, an uplink transmission time determined by the first parameter set comprises multiple time periods.

In one subembodiment, each of the multiple time periods during the uplink transmission time is of equal length.

In one subembodiment, the multiple time periods during the uplink transmission time include at least two time periods of unequal lengths.

In one subembodiment, any two adjacent time periods among the multiple time periods during the uplink transmission time are spaced apart from each other by equal time interval.

In one subembodiment, the multiple time periods during the uplink transmission time include at least one pair of adjacent time periods with a time interval between them not equal to a time interval between another pair of adjacent time periods.

In one embodiment, the first parameter set explicitly indicates a parameter for uplink transmission time.

In one embodiment, the first parameter set indicates which of previous configurations is used to configure the uplink transmission time.

In one subembodiment, the first parameter set indicates a configuration index.

In one subembodiment, the network configures a candidate uplink transmission time before the first parameter set.

In one embodiment, the first parameter set includes a time for transmitting a system information block.

In one embodiment, the first parameter set comprises a time for transmitting an SSB.

In one embodiment, the first parameter set comprises a first factor, the first factor being used together with a first time length to determine the uplink transmission time.

In one subembodiment, the first factor is a scaling factor.

In one subembodiment, the first time length is a period of a SIB.

In one subembodiment, the first time length is a period of a SIB1.

In one subembodiment, the first time length is a period of an SSB.

In one subembodiment, the first time length is a period of paging.

In one subembodiment, the first time length is a period of Discontinuous Reception.

In one subembodiment, the first factor is unequal to 1.

In one subembodiment, the first factor is greater than 1.

In one subembodiment, the product of the first factor and the first time length is used to determine a time interval between any two adjacent time periods among the multiple time periods in the uplink transmission time.

In one embodiment, the first parameter set indicates the uplink transmission time by indicating the time other than the uplink transmission time.

In one embodiment, the uplink transmission time is for the first cell.

In one embodiment, the uplink transmission time is a time while the first cell is in an active state.

In one embodiment, the uplink transmission time is a time while the first cell is in the first state.

In one embodiment, the uplink transmission time is a time while the first cell is in a non-network energy saving (non-NES) state.

In one embodiment, the uplink transmission time is a time other than the time while the first cell is in DRX.

In one embodiment, the uplink transmission time is an active time while the first cell is in DRX.

In one embodiment, the first parameter set comprises at least one time parameter of a reference signal resource.

In one embodiment, the first parameter set comprises a period of the uplink transmission time.

In one embodiment, the first parameter set comprises a period of a time period of the uplink transmission time.

In one embodiment, the first parameter set comprises time window information for a system information block.

In one embodiment, the period of the time period included in the uplink transmission time is equal to the period of the system information block.

In one embodiment, the uplink transmission time is partially or fully overlapped with a downlink reception time determined by the first parameter set.

In one embodiment, the uplink transmission time is non-overlapped with a downlink reception time determined by the first parameter set.

In one embodiment, the uplink transmission time has a fixed offset in time from a downlink reception time determined by the first parameter set.

### Embodiment 8

Embodiment 8 illustrates a schematic diagram of a first parameter set being used to determine at least one of a downlink reception time or an uplink transmission time according to one embodiment of the present application.

In one embodiment, the first parameter set comprises a configuration index or a configuration identity, the configuration index or configuration identity being used to identify a configuration used to configure at least one of the downlink reception time or the uplink transmission time.

In one embodiment, the first parameter set is used to determine the downlink reception time, the downlink reception time being used to determine the uplink transmission time.

In one embodiment, the first parameter set is used to determine the uplink transmission time, the uplink transmission time being used to determine the downlink reception time.

In one embodiment, the first parameter set is used to indicate a start of at least one of the downlink reception time or the uplink transmission time.

In one embodiment, the first parameter set is used to indicate a duration of at least one of the downlink reception time or the uplink transmission time.

In one embodiment, the first parameter set is used to indicate an end of at least one of the downlink reception time or the uplink transmission time.

In one embodiment, the first parameter set is used to indicate a time period included in at least one of the downlink reception time or the uplink transmission time.

In one embodiment, the first parameter set is used to indicate a period of at least one of the downlink reception time or the uplink transmission time.

In one embodiment, the first parameter set comprises a first offset, the first offset being used to indicate at least one of the downlink reception time or the uplink transmission time.

In one subembodiment, the first offset indicates a time offset of at least one of the downlink reception time or the uplink transmission time relative to system information.

In one subembodiment, the first offset indicates a time offset of at least one of the downlink reception time or the uplink transmission time relative to a reference signal or a reference signal resource.

In one embodiment, the first parameter set comprises a system frame number, the system frame number being used to determine at least one of the downlink reception time and the uplink transmission time.

In one embodiment, the first parameter set indicates at least one of the downlink reception time and the uplink transmission time by indicating a relationship between at least one of the downlink reception time and the uplink transmission time and system information.

In one embodiment, the first parameter set indicates the downlink reception time by indicating the time other than the downlink reception time.

In one embodiment, the first parameter set indicates the uplink transmission time by indicating the time other than the uplink transmission time.

In one embodiment, the first parameter set indicates an immediate departure from downlink reception time.

In one embodiment, the first parameter set indicates an immediate departure from uplink transmission time.

In one embodiment, the first parameter set indicates an instance of time of departure from the downlink reception time.

In one embodiment, the first parameter set indicates an instance of time of departure from the uplink transmission time.

In one embodiment, the first parameter set indicates a duration of departure from the downlink reception time.

In one embodiment, the first parameter set indicates a duration of departure from the uplink transmission time.

In one embodiment, the first parameter set includes a DTX parameter of the first cell to indicate the downlink reception time.

In one embodiment, the first parameter set includes a DRX parameter of the first cell to indicate the uplink transmission time.

In one embodiment, the first cell is not deactivated.

In one embodiment, the downlink reception time is not applicable to reference signals.

In one embodiment, the first node may perform a measurement for the first cell at a time other than the downlink reception time.

In one embodiment, the first node may perform a measurement for a reference signal resource of the first cell at a time other than the downlink reception time.

In one embodiment, the first parameter set comprises a template of the downlink reception time.

In one embodiment, the first parameter set comprises a template of the uplink transmission time.

In one embodiment, after receiving the first parameter set, there exists at least one period of time that is not a part of downlink reception time.

In one embodiment, after receiving the first parameter set, there exists at least one period of time that is not a part of uplink transmission time.

In one embodiment, the first parameter set is cell targeted.

In one embodiment, the first parameter set is not specific to a single user.

In one embodiment, during the downlink reception time determined by the first parameter set, the first node may be in an active time of DRX or in an inactive time of the DRX.

In one embodiment, during the uplink transmission time determined by the first parameter set, the first node may be in an active time of DRX or in an inactive time of the DRX.

### Embodiment 9

Embodiment 9 illustrates a schematic diagram of a second signaling being used to indicate a first parameter set according to one embodiment of the present application, as shown in FIG. 9.

In one embodiment, the second signaling explicitly comprises the first parameter set.

In one embodiment, the second signaling indicates an identity of the first parameter set.

In one embodiment, the second signaling indicates whether the first parameter set is applied.

In one embodiment, the second signaling indicates that the first parameter set is applied to the first cell.

In one embodiment, an RRC signaling other than the second signaling indicates the first parameter set and the second signaling indicates application of the second parameter set.

In one subembodiment, the RRC signaling comprises RRCReconfiguration.

In one subembodiment, the RRC signaling comprises RRCConnectionReconfiguration.

In one embodiment, the second signaling indicates whether the first parameter set is being applied.

In one embodiment, the second signaling indicates whether the first parameter set is being applied to the first cell.

In one embodiment, after application of the first parameter set, the first cell does not transmit any signal for at least part of the time.

In one embodiment, after application of the first parameter set, the first cell does not receive any signal for at least part of the time.

### Embodiment 10

Embodiment 10 illustrates a structure block diagram of a processing device used in a first node according to one embodiment of the present application, as shown in FIG. 10. In FIG. 10, a processing device 1000 in a first node is comprised of a first receiver 1001 and a first transmitter 1002.

In Embodiment 10, the first receiver 1001 receives a first signaling, the first signaling being used for configuration of measurements, including indicating a first report type and a second report type; both the first report type and the second report type being types of configured measurement reports; and
the first transmitter 1002 reports measurement results according to either of the first report type and the second report type; whether a first parameter set is indicated being used to determine whether to report measurement results according to the first report type or the second report type; the first parameter set being used to determine at least one of a downlink reception time or an uplink transmission time;
herein, the meaning of the sentence whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

In one embodiment, the first signaling comprises a first report configuration, the first report configuration including the first report type; and the first signaling comprises a second report configuration, the second report configuration including the second report type.

In one embodiment, the first signaling comprises a first report configuration, and both the first report type and the second report type are candidate report types of the first report configuration.

In one embodiment, the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;
herein, the first measurement object includes at least a first reference signal resource, while the second measurement object includes at least a second reference signal resource.

In one embodiment, whether the first parameter set is indicated is used to determine whether to perform measurements according to the first measurement object or the second measurement object;

herein, the meaning of the sentence whether the first parameter set is indicated is used to determine whether to perform measurements according to the first measurement object or the second measurement object is: when the first parameter set is indicated, performing measurements according to the first measurement object; when the first parameter set is not indicated, performing measurements according to the second measurement object.

In one embodiment, one of the first report type and the second report type is periodical and the other is not periodical, or neither of the first report type and the second report type is periodical.

In one embodiment, both the first report type and the second report type are periodical; the period of the first report type is different from the period of the second report type.

In one embodiment, both the first report type and the second report type are event-triggered; triggering events of the first report type are different from triggering events of the second report type.

In one embodiment, the first receiver receives a second signaling, the second signaling being used to indicate the first parameter set;
the first transmitter reports measurement results according to the first report type as a response to receiving the second signaling;
the first receiver receives a third signaling after the second signaling is received, the third signaling being used to indicate a stop of application of the first parameter set; and
the first transmitter reports measurement results according to the second report type as a response to receiving the third signaling;

In one embodiment, the second signaling and the third signaling are both transmitted by means of broadcasting.

In one embodiment, the first node is a UE.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

### Embodiment 11

Embodiment 11 illustrates a structure block diagram of a processing device used in a first node according to one embodiment of the present application, as shown in FIG. 11. In FIG. 11, a processing device 1100 in a first node is comprised of a first receiver 1101 and a first transmitter 1102.

In Embodiment 11, the first receiver 1101 receives a first signaling, the first signaling being used for configuration of measurements, including indicating a first report type and a second report type; both the first report type and the second report type being types of configured measurement reports; and
the first transmitter 1102 reports measurement results according to at least the former of the first report type and the second report type; whether a first parameter set is indicated being used to determine whether to report measurement results according to the second report type; the first parameter set being used to determine at least one of a downlink reception time or an uplink transmission time;
herein, the meaning of the sentence whether a first parameter set is indicated being used to determine whether to report measurement results according to the second report type is: when the first parameter set is indicated, reporting measurement results according to only the former of the first report type and the second report type; when the first parameter set is not indicated, reporting the measurement results only according to the first report type and the second report type.

In one embodiment, the first signaling comprises a first report configuration, the first report configuration including the first report type; and the first signaling comprises a second report configuration, the second report configuration including the second report type.

In one embodiment, the first signaling comprises a first report configuration, and both the first report type and the second report type are candidate report types of the first report configuration.

In one embodiment, the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;

herein, the first measurement object includes at least a first reference signal resource, while the second measurement object includes at least a second reference signal resource.

In one embodiment, whether the first parameter set is indicated is used to determine to perform measurements according to the second measurement object;

herein, the meaning of the sentence whether the first parameter set is indicated is used to determine whether to perform measurements according to the first measurement object or the second measurement object is: when the first parameter set is indicated, performing measurements according to only the former of the first measurement object and the second measurement object; when the first parameter set is not indicated, performing measurements according to the first measurement object and the second measurement object.

In one embodiment, one of the first report type and the second report type is periodical and the other is not periodical, or neither of the first report type and the second report type is periodical.

In one embodiment, both the first report type and the second report type are periodical; the period of the first report type is different from the period of the second report type.

In one embodiment, both the first report type and the second report type are event-triggered; triggering events of the first report type are different from triggering events of the second report type.

In one embodiment, the first receiver receives a second signaling, the second signaling being used to indicate the first parameter set;
the first transmitter reports measurement results according to the first report type as a response to receiving the second signaling;
the first receiver receives a third signaling after the second signaling is received, the third signaling being used to indicate a stop of application of the first parameter set; and
the first transmitter reports measurement results according to the first report type and the second report type as a response to receiving the third signaling.

In one embodiment, the second signaling and the third signaling are both transmitted by means of broadcasting.

In one embodiment, the first node is a UE.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This invention can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, which receives a first signaling, the first signaling being used for configuration of measurements, including indicating a first report type and a second report type; both the first report type and the second report type being types of configured measurement reports; and
a first transmitter, which reports measurement results according to either of the first report type and the second report type; whether a first parameter set is indicated being used to determine whether to report measurement results according to the first report type or the second report type; the first parameter set being used to determine at least one of a downlink reception time or an uplink transmission time;
wherein the meaning of whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

2. The first node according to claim 1, characterized in that
the first signaling comprises a first report configuration, the first report configuration including the first report type; and the first signaling comprises a second report configuration, the second report configuration including the second report type.

3. The first node according to claim 1, characterized in that
the first signaling comprises a first report configuration, and both the first report type and the second report type are candidate report types of the first report configuration.

4. The first node according to claim 1, characterized in that
the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;
wherein the first measurement object includes at least a first reference signal resource, while the second measurement object includes at least a second reference signal resource.

5. The first node according to claim 3, characterized in that
the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;
wherein the first measurement object includes at least a first reference signal resource, while the second measurement object includes at least a second reference signal resource.

6. The first node according to claim 4, characterized in that
whether the first parameter set is indicated is used to determine whether to perform measurements according to the first measurement object or the second measurement object;
wherein the meaning of whether the first parameter set is indicated is used to determine whether to perform measurements according to the first measurement object or the second measurement object is: when the first parameter set is indicated, performing measurements according to the first measurement object; when the first parameter set is not indicated, performing measurements according to the second measurement object.

7. The first node according to claim 5, characterized in that
whether the first parameter set is indicated is used to determine whether to perform measurements according to the first measurement object or the second measurement object;
wherein the meaning of whether the first parameter set is indicated is used to determine whether to perform measurements according to the first measurement object or the second measurement object is: when the first parameter set is indicated, performing measurements according to the first measurement object; when the first parameter set is not indicated, performing measurements according to the second measurement object.

8. The first node according to claim 1, characterized in that
one of the first report type and the second report type is periodical and the other is not periodical, or neither of the first report type and the second report type is periodical.

9. The first node according to claim 3, characterized in that
one of the first report type and the second report type is periodical and the other is not periodical, or neither of the first report type and the second report type is periodical.

10. The first node according to claim 1, characterized in that
both the first report type and the second report type are periodical; the period of the first report type is different from the period of the second report type.

11. The first node according to claim 3, characterized in that
both the first report type and the second report type are periodical; the period of the first report type is different from the period of the second report type.

12. The first node according to claim 1, characterized in that
both the first report type and the second report type are event-triggered; triggering events of the first report type are different from triggering events of the second report type.

13. The first node according to claim 3, characterized in that
both the first report type and the second report type are event-triggered; triggering events of the first report type are different from triggering events of the second report type.

14. The first node according to claim 1, characterized in comprising:
the first receiver, which receives a second signaling, the second signaling being used to indicate the first parameter set;
the first transmitter, which reports measurement results according to the first report type as a response to receiving the second signaling;
the first receiver, which receives a third signaling after the second signaling is received, the third signaling being used to indicate a stop of application of the first parameter; and
the first transmitter, which reports measurement results according to the second report type as a response to receiving the third signaling;
wherein the second signaling and the third signaling are both transmitted by means of broadcasting.

15. A method in a first node for wireless communications, comprising:
receiving a first signaling, the first signaling being used for configuration of measurements, including indicating a first report type and a second report type; both the first report type and the second report type being types of configured measurement reports; and
reporting measurement results according to either of the first report type and the second report type; whether a first parameter set is indicated being used to determine whether to report measurement results according to the first report type or the second report type; the first parameter set being used to determine at least one of a downlink reception time or an uplink transmission time;
wherein the meaning of whether a first parameter set is indicated being used to determine whether to report measurement results according to the first report type or the second report type is: when the first parameter set is indicated, reporting measurement results according to the first report type; when the first parameter set is not indicated, reporting the measurement results according to the second report type.

16. The method in the first node according to claim 15, characterized in that
the first signaling comprises a first report configuration, and both the first report type and the second report type are candidate report types of the first report configuration.

17. The method in the first node according to claim 15, characterized in that
the first signaling indicates a first measurement object and a second measurement object, the first report type being associated with the first measurement object; the second report type being associated with the second measurement object; each of the first measurement object and the second measurement object includes a first cell; the first parameter set is used to determine at least one of a downlink reception time or an uplink transmission time for the first cell;
wherein the first measurement object includes at least a first reference signal resource, while the second measurement object includes at least a second reference signal resource.

18. The method in the first node according to claim 15, characterized in that
one of the first report type and the second report type is periodical and the other is not periodical, or neither of the first report type and the second report type is periodical.

19. The method in the first node according to claim 15, characterized in that
both the first report type and the second report type are periodical; the period of the first report type is different from the period of the second report type.

20. The method in the first node according to claim 15, characterized in that
both the first report type and the second report type are event-triggered; triggering events of the first report type are different from triggering events of the second report type.
